(19) United States
(12) Patent Application Publication
(10) Pub. No.: US 2024/0016323 A1
(43) Pub. Date: Jan. 18, 2024

(54) Illuminated Drink Coaster

(71) Applicant: Yefim Kats, Brooklyn, NY (US)

(72) Inventor: Yefim Kats, Brooklyn, NY (US)

(21) Appl. No.: 17/846,560

(22) Filed: Jun. 22, 2022

(51) Int. Cl. A47G 23/03; F21V 23/04; F21V 23/00; F21V 23/02; F21V 33/00

(52) U.S. Cl. CPC A47G 23/0309; F21V 23/0414; F21V 23/002; F21V 23/023; F21V 33/0036; F21Y 2115/10

(57) ABSTRACT

A drink coaster is provided with a one or more light-emitting diodes, which collectively are capable of emitting at least two different colors of light, and a power supply for illuminating the diodes. An individual using the coaster is provided with means for controlling the on/off status of the diodes, thereby controlling the color of the emitted light.

### FIELD OF THE INVENTION

This invention is directed to the field of illuminated signaling devices, more particularly to an illuminated coaster suitable for use in a dark bar or grill.

### BACKGROUND

Patrons at bars are very often seeking to meet and get acquainted with other people, in particular other patrons who are likewise seeking to meet people. It is, however, rarely obvious which of the other patrons are amenable to being approached in order to start a conversation, and which are not interested in being approached. The latter patrons may find it annoying to have to constantly rebuff such approaches, sometimes to the extent that they will not patronize certain establishments. Constant approaches by aggressive patrons can contribute to an unpleasant, so-called “meat market” atmosphere, which discourages potential customers. The experience of repeated rejections is also unpleasant for those persons who are seeking to meet others.

There is a need for a means by which patrons can passively indicate their lack of interest in making new acquaintances, so that they can avoid the need to repeatedly, personally interact with patrons who are so interested. Such a means of passive communication would make an evening at a bar more pleasant for all patrons.

Due to crowded conditions, low light, and high levels of noise, patrons at a busy bar can also find it difficult to get the attention of a bartender or waitperson. There is thus a need for a means by which patrons can signal to a bartender or waitperson that they are need of service—whether to place an order or to settle their bill.

Both of the above communication needs could be met by a device that gives of an easily-noticed visible signal. The present invention takes an item already present in front of most patrons at a bar—a drink coaster—and adds a visual indicator in the form of a color-coded light-emitting diode (LED). The patron, via a switch on the device, can illuminate an LED of a selected color, and with very little effort communicate information to others in a crowded, noisy environment.

Illuminated drink coasters are known in the art for decorative purposes, typically for the illumination of a beverage for decorative or aesthetic effect. Representative examples of decorative illuminated coasters can be found in U.S. Pat. Nos. 4,858,084, 5,784,265, 6,082,866, and 6,793,363. The use of an illuminated coaster to silently convey information has been disclosed in U.S. Patent Application Publication No. 2018/0130147, which describes a coaster equipped with illumination for signaling to a bartender or waiter a request for service, such as a drink refill or a check request.

These prior art devices are not absorbent, and are far too costly for single-use applications, yet they cannot be immersed or cleaned in a dishwasher for re-use in a commercial establishment. Being approximately pocket-sized, they are particularly attractive as objects of petty theft, with a high likelihood of being stolen by patrons. The relatively high price of the prior art devices, combined with the ease of theft and the need to hand-clean them, renders them unsuitable for use in large numbers at a busy bar, and they have not found acceptance in the marketplace. There remains a need for an inexpensive, disposable, absorbent drink coaster with LED signaling functionality.

### BRIEF DESCRIPTION OF THE INVENTION

The invention provides an economical, preferably single-use beverage coaster that is equipped with one or more light-emitting diodes (LEDs), which are capable of emitting one or more different colors of light. The coaster also includes a power source, preferably a battery, and one or more operatively-connected switches for controlling the illumination of the LED(s) and the color of the emitted light.

The person using the coaster can, by operation of the switch or switches, cause one or more of the LEDs to become illuminated. The presence of an illuminated LED, and the color emitted, constitute a signal that servers and other patrons can recognize and immediately interpret. Servers and bartenders, for example, can be informed by an illuminated LED of the user's desire to order a drink, regardless of the noise level in the establishment.

It is also anticipated that widespread adoption of the present invention would result in a general understanding that a certain color of light conveys a certain social message. By way of example, it could be understood that a glowing red LED indicates that the user does not wish to be approached by strangers. The absence of a light would then indicate at least the possibility that the user is amenable to being approached. Where the user is enabled to activate a green LED, this could be understood to indicate a positive interest in meeting others.

### BRIEF DESCRIPTION OF THE DRAWINGS

FIG. 1 is a cross section of a representative coaster of the invention, showing the presence of a two-color LED, battery, and microswitch mounted on a circuit board.

FIG. 2 is an overhead view of a representative coaster of the invention.

### DETAILED DESCRIPTION OF THE INVENTION

The coaster of the invention can be based on any existing coaster design, whether absorbent or impermeable, but disposable, absorbent articles represent the preferred embodiment. The invention provides illuminated coasters that can be less than 3 mm, or even less than 2 mm, in thickness, which are absorbent and which are inexpensive enough to use as disposable items—features that are essential to commercial acceptance but not made available by prior designs. The coasters of the invention can be made by modification of already-manufactured coasters, and thus can be manufactured without re-tooling of existing production facilities. For purposes of illustration, the preferred, single-use absorbent embodiment will be described in detail and shown in the drawings.

Single-color, bi-color and tri-color LEDs, having dimensions on the order of one millimeter or less, are well known in the electronics arts. LEDs are available packaged in protective, clear plastic capsules with wire leads (“through-hole”) and as surface-mounted devices (“SMD”). The latter, due to their sub-millimeter dimensions, are particularly suitable for use in the invention. Such LEDs typically illuminate when provided with a forward voltage of 2.0-2.5 V, with current typically being limited to about 20 mA. The LEDs are normally provided sealed into an integrated LED package, which provides electrical contacts for mounting to a circuit board, and preferably a clear plastic lens to direct the emitted light upward.

In a preferred embodiment, a bi-color or tri-color LED is employed. For example, a red/green bi-color LED is constructed with two LEDs in opposite orientation, so that reversing the applied voltage causes the color to switch from red to green. A tri-color LED can use the same red and green LEDs, but in parallel orientation and having a common cathode. Applying a forward voltage to either LED produces the corresponding color, and applying a forward voltage to both at the same time results in a combination of red and green light, which the human eye interprets as a yellow or amber light. Bi-color and tri-color LEDs in through-hole and SMD configurations are readily available articles of commerce. A particularly preferred LED is the red/green bi-color surface-mount QuasarBrite™ SMD LED, model SML-LX0606SRSGC-TR marketed by Lumex Inc. of Carol Stream, IL.

The power source of the invention comprises a battery, together with any circuitry required to regulate the current delivered to the LEDs. Current regulation can be accomplished by any means known in the art, but is preferably effected by the placement of a current-limiting SMD resistor in series with each LED. In certain embodiments, the battery itself may have sufficient internal resistance to ensure that excessive current does not flow, but at least one resistor will still be required if the LEDs have different forward currents. The battery may comprise one or more electrochemical cells. The cells may employ any known chemistry, including but not limited to alkaline, silver oxide, nickel metal hydride, and lithium ion batteries. Miniature alkaline or silver oxide batteries of less than 2 mm thickness, designed for use in hearing aids and watches, are readily-available articles of commerce, and are preferred. Suitable sizes include SR62 (5.8×1.6 mm) and SR512 (5.8×1.3 mm), which enable an overall height of 2 mm for a coaster of the invention. Two cells in series may be employed if needed to provide the forward voltage required by the selected LED package.

The electrical circuitry of the invention is minimal, requiring only conductors from the battery to the LED package leads, and a manually-operable switch to direct the flow of current from the battery to the user-selected LED. A single, flexible circuit board or “flex circuit” having a surface-mounted LED package is preferred, as it provides the requisite low cost and thin cross-section. A flex circuit consists of a metallic layer of conductive traces, usually copper, bonded to a polyimide or polyester dielectric layer. The thickness of the metal layer preferably ranges from 0.0001 in. to 0.001 in. and the thickness of the dielectric substrate preferably ranges from 0.01 in. to 0.010 in. The metal layer is typically bonded to the dielectric substrate with an adhesive, and is then formed into the desired circuit pattern by a subtractive (etching) process. Photolithography is commonly used for the large-scale production of flex circuits. A thin solder layer may be applied at mounting points to facilitate the attachment of electrical components. Preferably, in the present invention, a protective polymer layer is applied, to isolate the circuit traces from moisture absorbed by the coaster. This is highly desirable, as salt-containing liquids (e.g. from the salt rim of a margarita) may be encountered in use. Hundreds or even thousands of the small flex circuits of the invention can be created on a single sheet of substrate, to be cut apart in the final step of manufacture.

Battery holders for the commercially-available battery sizes, suitable for surface mounting, are readily available. Alternatively, the need for a battery holder can be eliminated by folding a portion of the flex circuit over the battery so as to make electrical contact with both battery terminals. A metal or plastic clip, or an adhesive, can be used to stabilize such a configuration.

The only additional hardware required to complete the device is a microswitch. Surface-mounted 2-, 3- and 4-position microswitches of the appropriate dimensions are commercially available. The slide may be top-mounted, in which case the switch will be presented in a cutout on the upper surface of the coaster. In the embodiment shown in the drawings, a side-mounted slide is employed, and the switch is presented on the edge of the coaster.

In certain alternative embodiments of the invention, a momentary push-button switch can be employed, in combination with an integrated circuit that maintains the selected switching state of the device. Successive activations of the momentary switch will cycle the device through the off state and the available modes of LED illumination. Push-button switches may be presented on the upper surface of the coaster, or in certain embodiments may be located beneath the surface of the coaster, and activated by pressing down on the coaster at a marked location directly above the switch.

The flex circuit of the invention, with attached battery, LED package, and switch, is thin enough to be embedded within a standard 2 mm absorbent drink coaster, which has been provided with a void volume sufficient to accommodate the circuitry.

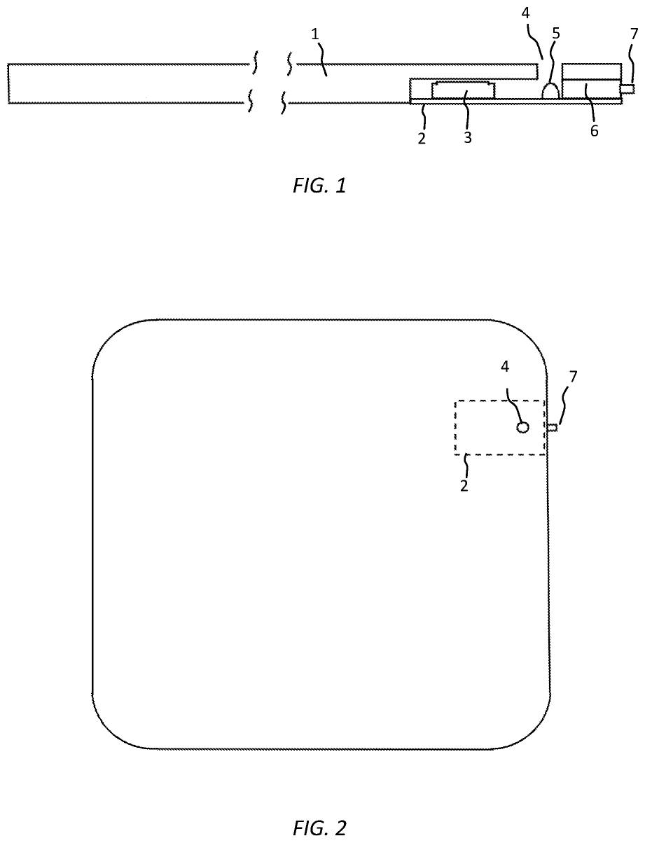

FIG. 1 of the drawings represents a cross-section of a representative coaster of the invention. The coaster, in this embodiment, comprises an absorbent fiber-based coaster 1 of conventional size and material. A portion of the absorbent material has been removed (e.g. by a routing process) to create a component volume for a flexible circuit board 2. The board carries a button battery 3 in a surface-mounted battery holder (not shown), a surface-mounted LED package 5, and a microswitch 6. The switch slider 7 projects beyond the edge of the coaster, so that it can be operated by the user. A hole 4 in the coaster is aligned with the LED package, so that light emitted by the LED package can be seen by observers. The microswitch is preferably a 3-position switch, providing the circuit with off, red LED on, and green LED on states. A 4-position switch can provide, in addition, a red LED on+green LED on state, in which the emitted combination of red and green light is perceived as yellow or amber. As noted above, in alternative embodiments a single momentary switch, in combination with a surface-mounted switching IC, can provide the same functionality.

The arrangement of elements shown in FIG. 1 is representative; the only requirements are that the switch be accessible to the user, and that any light emitted by the LED package be visible to observers. The circuit can be inverted, for example, with the flex circuit adhered to the underside of the component volume. The LED package in this arrangement would be mounted on the reverse side of the flex circuit, which would have through-holes providing backside conductive mounting pads, and would project into the hole 4. In yet another embodiment, the entire electronics package (elements 2-7) may be embedded in or contained within a thin plastic case, which is fitted into the component volume.

FIG. 2 is a top view of a representative coaster of the invention, showing a suitable location for the flex circuit 2, hole 4 and switch slider 7. It will be appreciated that the circuit and switch may be located at any point along an edge of the coaster, and that coasters of other shapes (circular, hexagonal, etc.) are equally suitable embodiments of the invention.

The invention has been described by reference to particular embodiments, which are detailed above and shown in the drawings. These descriptions and illustrations should be understood to be representative examples, and no limitations on the scope of the invention, other than those explicitly stated, should be inferred from the present disclosure. Modifications and substitutions of certain elements of the invention will be apparent to those skilled in the art, and such modifications and substitutions are contemplated by the inventor to be within the scope and spirit of the invention.

1. An illuminated coaster for a beverage container, comprising
(a) a base having a flat upper surface, suitable for resting a beverage container thereon, the base consisting of an absorbent material and defining a cavity therein,
(b) one or more light-emitting diodes,
(c) one or more batteries located within the cavity, the one or more batteries being capable of delivering voltage and current sufficient to illuminate the one or more light-emitting diodes, and
(d) one or more switches operatively connected to the battery and operatively connected to the one or more light-emitting diodes, so as to separately control the illumination of each of the one or more light-emitting diodes,
wherein the light-emitting diodes, one or more batteries, and switches are mounted on a circuit board located within the cavity;
wherein the one or more light-emitting diodes are located along an edge of the coaster, and are aligned with a hole in the coaster, so as to be seen by observers;
and
wherein the coaster, light-emitting diodes, one or more batteries, and switches together form an illuminated coaster that is no greater than 3 mm in thickness.

2. The illuminated coaster according to claim 1, wherein the coaster, light-emitting diodes, power source, and switches together form an illuminated coaster that is no greater than 2 mm in thickness.

3. The illuminated coaster according to claim 1, wherein power is delivered to the light-emitting diodes via conductive traces on a flexible substrate.

4-6. (canceled)

7. The illuminated coaster according to claim 2, wherein power is delivered to the light-emitting diodes via conductive traces on a flexible substrate.
